(19) United States
(12) Patent Application Publication
(10) Pub. No.: US 2005/0173183 A1
(43) Pub. Date: Aug. 11, 2005

(54) Vehicle power steering device

(75) Inventor: Kazuo Chikaraishi, Gunma-ken (JP)

Correspondence Address: MILES & STOCKBRIDGE PC, 1751 PINNACLE DRIVE, SUITE 500, MCLEAN, VA, 22102-3833, US

(73) Assignee: NSK Ltd., Shinagawa-ku (JP)

(21) Appl. No.: 10/519,226

(22) PCT Filed: May 7, 2003
(86) PCT No.: PCT/JP03/05684

(30) Foreign Application Priority Data
Jun. 27, 2002 (JP) 2002-188312

(51) Int. Cl. B62D 5/04

(52) U.S. Cl. 180/444

(57) ABSTRACT

An electric power steering apparatus is constructed such that a rotational output of a drive source is, as an auxiliary steering torque, decelerated by a worm gear speed reducer and thus transmitted to a steering shaft so as to assist a steering force applied to a steering wheel, and travelling wheels are thereby steered, wherein the electric power steering apparatus includes cooling means for cooling an interior of a gear chamber of the worm gear speed reducer by circulating the air within the gear chamber thereof.

### TECHNICAL FIELD

The present invention relates to a power steering apparatus for a vehicle that includes a worm gear speed reducer.

### BACKGROUND ARTS

What is known as an electric power steering apparatus for a vehicle is constructed such that a rotational output of an electric motor, which serves an auxiliary steering torque, is decelerated by a power transmission mechanism and thus transmitted to a steering shaft, and travelling wheels are steered in a way that a steering force applied to a steering wheel is assisted.

In this type of electric power steering apparatus, the power is transmitted to an output shaft while decelerating rotations of the electric motor by use of the power transmission mechanism provided within housing. As this power transmission mechanism, there is generally used a worm gear speed reducer for the reason of its being excellent in terms of a layout characteristic.

In this type of gear speed reducer, a smooth torque transmission inevitably involves a backlash. If the backlash occurs, however, butting noises (rattle noises) are produced between tooth faces of meshing teeth when in reversed rotations thereof.

The meshing tooth of the worm is made from a metal, however, the meshing tooth of the worm wheel is made from a resin in order to smoothly transmit the torque by reducing those butting noises.

The worm gear speed reducer is a mechanism for transmitting rotations to between two shafts different in their axial directions and disposed apart from each other, wherein the meshing tooth faces of the worm and of the worm wheel are formed to transmit the rotations through their slide contact and therefore cause a slide loss. Transmission efficiency is on the order or 90% even in the case of taking gear specifications enabling a reversed operation for a steering apparatus, and at least a 10% loss is induced.

This 10% loss appears as a heat emission at a meshing portion between the meshing teeth, and a heat generation quantity rises proportionally as the transmission power increases. Besides, the meshing tooth of the worm wheel is resinous and has a poor coefficient of thermal conductivity as compared with the metal. This resinous tooth is hard to let the heat escape, with the result that a temperature of the meshing portion between the meshing teeth of the worm and of the worm wheel is extremely easy to rise.

When the temperature of the meshing portion rises, rigidity of the resin of the meshing tooth declines, resulting in a large abrasion. Further, deterioration of a lubricating grease gets progressed. As a result, if a lubrication defect once occurs due to the deterioration of the lubricating grease, the mechanism falls into a vicious circle that a frictional coefficient between the tooth faces of the meshing teeth increases, and the heat generation quantity further rises. Then, the abrasion of the resinous meshing tooth gets advanced very soon, and therefore the resinous meshing tooth might have comparatively a short lifetime.

This being the case, when trying to mount the electric power steering apparatus on a vehicle having a heavy weight and requiring a large auxiliary steering force, there is adopted a worm gear speed reducer having large transmission power corresponding to the large auxiliary steering force. In fact, however, it is required to use the worm gear speed reducer having much larger transmission power in consideration of the deterioration of the resinous meshing tooth that is caused by the heat loss. This brings about a scale-up of the worm gear speed reducer, which hinders mountability on the vehicle.

What has described above leads to demands for preventing the deterioration of the meshing tooth that is caused by the heat loss and for scheming to consequently increase the life-time by improving durability of the meshing tooth and to downsize the worm gear speed reducer.

Note that Japanese Patent Application Laid-Open No. 2002-54696 discloses a construction, wherein the worm is provided with a lubricating agent reservoir from which a lubricating agent is supplied to the meshing tooth as the worm rotates, thereby preventing the abrasion of the meshing tooth to attain improved durability. There is, however, disclosed nothing about cooling the interior of the gear chamber of the worm gear speed reducer.

### DISCLOSURE OF THE INVENTION

It is an object of the present invention, which was devised under such circumstances, to provide a power steering apparatus for a vehicle, which is capable of increasing a lifetime by improving durability of a meshing tooth and of downsizing a worm gear speed reducer.

To accomplish the above object, in an electric power steering apparatus constructed such that a rotational output of a drive source is, as an auxiliary steering torque, decelerated by a worm gear speed reducer and thus transmitted to a steering shaft so as to assist a steering force applied to a steering wheel, and travelling wheels are thereby steered, a power steering apparatus for a vehicle according to the present invention includes cooling means for cooling an interior of a gear chamber of the worm gear speed reducer.

According to the present invention, since the cooling means for cooling the interior of the gear camber of the worm gear speed reducer is provided, the worm is cooled, and also the meshing tooth of the worm wheel is cooled as well. This prevents deterioration of the meshing tooth that is caused by a heat loss, thereby scheming to increase a lifetime of the meshing tooth with improved durability thereof and to downsize the worm gear speed reducer. Mountability of the downsized worm gear speed reducer on the vehicle can be therefore improved.

In the power steering apparatus for the vehicle according to the present invention, preferably the cooling means can be constructed of a cooling fan attached to a worm of the worm gear speed reducer. According to this construction, the cooling fan is fitted to the worm of the worm gear speed reducer. Therefore, in the interior of the worm gear, the cooling fan rotates as the worm rotates, whereby the air is forcibly circulated within the chamber, thus cooling the worm and also the meshing tooth of the worm wheel. This prevents the deterioration of the meshing tooth that is caused by the heat loss, thereby scheming to increase the lifetime of the meshing tooth with the improved durability thereof and to downsize the worm gear speed reducer. The mountability of the downsized worm gear speed reducer on the vehicle can be therefore improved.

Further, heat radiation of the meshing tooth of the worm is accelerated by positively blowing the air onto the surface of the meshing tooth of the metallic worm exhibiting comparatively a high coefficient of thermal conductivity. The surface of the meshing tooth of the worm, of which a temperature consequently decreases, is brought into contact with the meshing tooth of the worm wheel, thereby enabling a further decrease in temperature of the meshing tooth of the worm wheel.

Moreover, a heat generation quantity (W) rises in proportion with transmission power and is given by Tooth Face Pressing Load (N)×Frictional Coefficient ×Slide Speed (m/s). The heat generation quantity (W) is also proportional to the number of rotations. Hence, the cooling fan, which increases an air flow rate as the number of rotations rises, is provided, whereby the heat from a meshing portion of the meshing tooth can be effectively radiated through air-cooling, and resultantly the life-time of the meshing tooth of the worm wheel can be improved.

In a second preferred aspect of the power steering apparatus for the vehicle according to the present invention, housing of the worm gear speed reducer may be provided with a circulation path for circulating the air in the gear chamber. Thus, when the housing of the worm gear speed reducer is provided with the circulation path for circulating the air in the gear chamber, the air circulation in the gear chamber can be further accelerated.

Still further, in a third preferred aspect of the power steering apparatus for the vehicle according to the present invention, it is preferable that heat radiation fins be formed on an external surface of the housing of the worm gear speed reducer.

Thus, when the heat radiation fins are formed on the external surface of the housing of the worm gear speed reducer. A heat radiation property can be further improved.

Note that in the power steering apparatus for the vehicle according to the present invention, a drive source of the auxiliary steering torque is not limited to an electric motor, and other drive sources are available. Further, a material of the meshing tooth of the worm wheel is not limited to a resin.

### BRIEF DESCRIPTION OF THE DRAWINGS

FIG. 1A is a vertical sectional view of an electric power steering apparatus in an embodiment of the present invention; FIG. 1B is a side view of a cooling fan; and

FIG. 2 is an enlarged side view of the cooling fan.

### THE EMBODIMENT OF THE INVENTION

A power steering apparatus for a vehicle in an embodiment of the present invention will hereinafter be described with reference to the drawings.

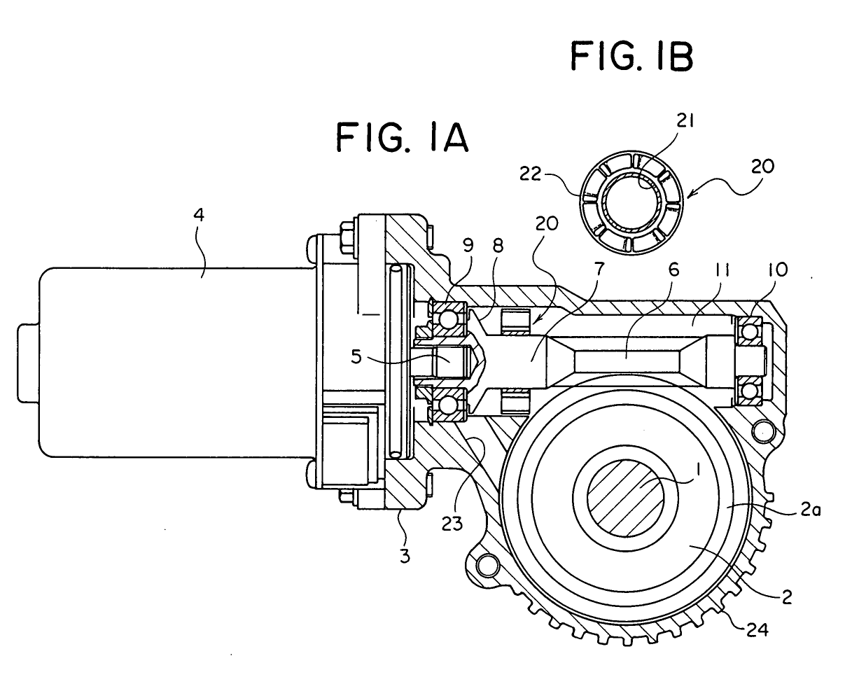

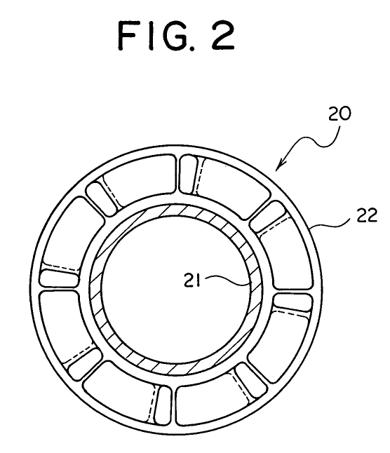

FIG. 1A is a vertical sectional view of the electric power steering apparatus according to one embodiment of the present invention. FIG. 1B is a side view of a cooling fan. FIG. 2 is an enlarged side view of the cooling fan.

As shown in FIG. 1A, in the electric power steering apparatus in the present embodiment, an output shaft 1 (steering shaft) is connected via a torsion bar (unillustrated) to a steering shaft (input shaft which is not shown) connected to a steering wheel (not shown). Worm wheel 2 of a worm gear speed reducer is fixed to this output shaft 1. The meshing teeth 2a of the worm wheel 2 are formed preferably of a resin.

An electric motor 4 is attached to housing 3 that accommodates the worm gear speed reducer. A drive shaft 5 of the electric motor 4 is formed with a male spline (or a male serration).

A worm shaft 7 having a worm 6 of the worm gear speed reducer integrally has a cylindrical portion 8 on the motor side, and an internal face of the cylindrical portion 8 is formed with a female spline (or a female serration).

The cylindrical portion 8 is spline-fitted (or serration-fitted) to the drive shaft 5 of the electric motor 4, whereby the worm shaft 7 becomes rotatable integrally with the drive shaft 5 and movable along the drive shaft 5 in an axial direction.

The worm shaft 7 is rotatably supported through bearings 9, 10 at both side ends thereof within the housing 3.

In the present embodiment, the cooling fan 20 is fitted to the worm shaft 7 of the worm gear speed reducer and can rotate together with the worm shaft 7.

As shown in FIGS. 1B and 2, the cooling fan 20 is constructed in such a way that a vane portion 22 is injection-molded of a resin and fitted to a metallic cored bar 21. Thus, the thus-constructed cooling fan 20 is fixedly press-fitted onto the worm shaft 7.

The housing 3 is formed with a circulation path 23 through which a portion on the side of the worm shaft 7 and a portion on the side of the worm wheel 2 within a gear chamber 11 communicate with each other, and this circulation path 23 serves to circulate the air within the gear chamber 11.

Further, an external surface of the housing 3 is formed with a multiplicity of heat radiation fins 24.

Thus, according to the present embodiment, the cooling fan 20 is fitted onto the worm shaft 7. Therefore, in the worm gear chamber 11, the cooling fan 20 rotates as the worm shaft 7 rotates, whereby the air is forcibly circulated within the gear chamber 11, thus cooling off the worm 6 and also the resinous meshing tooth 2a of the worm wheel 2. This prevents deterioration of the resinous meshing tooth 2a that is caused by a heat loss, thereby increasing a life-time of the resinous meshing tooth 2a with improved durability thereof and downsizing the worm gear speed reducer. Mountability of the downsized worm gear speed reducer on the vehicle can be therefore improved.

Further, the heat radiation of the meshing tooth of the worm 6 is accelerated by positively blowing the air onto the surface of the meshing tooth of the metallic worm 6 exhibiting comparatively a high coefficient of thermal conductivity. The surface of the meshing tooth of the worm 6, of which a temperature consequently decreases, is brought into contact with the resinous meshing tooth 2a of the worm wheel 2, thereby enabling a further decrease in temperature of the resinous meshing tooth 2a of the worm wheel 2.

Moreover, a heat generation quantity (W) rises in proportion with transmission power and is given by Tooth Face Pressing Load (N)×Frictional Coefficient ×Slide Speed (m/s). The heat generation quantity (W) is also proportional to the number of rotations. Hence, the cooling fan 20, which increases an air flow rate as the number of rotations rises, is provided, whereby the heat from a meshing portion of the meshing tooth 2a can be effectively radiated through air-cooling, and resultantly the life-time of the resinous meshing tooth 2a of the worm wheel 2 can be improved.

Moreover, the housing 3 is formed with the circulation path 23 for circulating the air within the gear chamber 11, and hence the air circulation within the gear chamber can be further accelerated.

For example, when rotating the worm shaft 7 in one direction, the cooling fan 20 rotates, and the air in the gear chamber 11 can be circulated along a route such as the cooling fan 20 the worm 6 the meshing teeth 2a of the worm wheel 2 an outer peripheral portion of the worm wheel 2→the circulation path 23. When rotating the worm shaft 7 in the other direction, the air flows in the opposite direction.

Furthermore, the external surface of the housing 3 is formed with the heat radiation fins 24, and it is therefore possible to further improve the heat radiation property.

Note that the present invention is not limited to the embodiment discussed above and can be modified in a variety of forms. In the power steering apparatus for the vehicle according to the present invention, a drive source of the auxiliary steering torque is not limited to the electric motor, and other drive sources are available. Further, the material of the meshing tooth of the worm wheel is not limited to the resin.

As discussed above, according to the present invention, since the cooling means for cooling the interior of the gear chamber of the worm gear speed reducer is provided, the worm is cooled, and also the meshing tooth of the worm wheel is cooled as well. This prevents the deterioration of the meshing tooth that is caused by the heat loss, thereby scheming to increase the lifetime of the meshing tooth with the improved durability thereof and to downsize the worm gear speed reducer. The mountability of the downsized worm gear speed reducer on the vehicle can be therefore improved.

1. In an electric power steering apparatus constructed such that a rotational output of a drive source is, as an auxiliary steering torque, decelerated by a worm gear speed reducer and thus transmitted to a steering shaft so as to assist a steering force applied to a steering wheel, and travelling wheels are thereby steered,
a power steering apparatus for a vehicle, comprising:
cooling means for cooling an interior of a gear chamber of said worm gear speed reducer.

2. A power steering apparatus for a vehicle according to claim 1, wherein said cooling means is constructed of a cooling fan attached to a worm of said worm gear speed reducer.

3. A power steering apparatus for a vehicle according to claim 1, wherein housing of said worm gear speed reducer is provided with a circulation path for circulating the air in said gear chamber.

4. A power steering apparatus for a vehicle according to claim 1, wherein said cooling means is constructed of heat radiation fins formed on an external surface of said housing of said worm gear speed reducer.

5. A power steering apparatus for a vehicle according to claim 3, wherein said cooling means is constructed of the heat radiation fins formed on the external surface of said housing of said worm gear speed reducer.

6. A power steering apparatus for a vehicle according to claim 2, wherein housing of said worm gear speed reducer is provided with a circulation path for circulating the air in said gear chamber.

7. A power steering apparatus for a vehicle according to claim 2, wherein said cooling means is constructed of heat radiation fins formed on an external surface of said housing of said worm gear speed reducer.

8. A power steering apparatus for a vehicle according to claim 6, wherein said cooling means is constructed of the heat radiation fins formed on the external surface of said housing of said worm gear speed reducer.
